(19) United States
(12) Patent Application Publication
(10) Pub. No.: US 2011/0079641 A1
(43) Pub. Date: Apr. 7, 2011

(54) METHOD AND SYSTEM FOR ACCURATELY LABELING A SPECIMEN AND TREATING A SUBJECT

(76) Inventor: Thomas L. CANTOR, El Cajon, CA (US)

(21) Appl. No.: 12/895,716

(22) Filed: Sep. 30, 2010

Related U.S. Application Data
(60) Provisional application No. 61/247,358, filed on Sep. 30, 2009.

(51) Int. Cl. G06K 5/00; G06K 7/01; G06K 7/14; G06K 7/10

(52) U.S. Cl. 235/375; 235/439; 235/454; 235/462.01

(57) ABSTRACT

Methods of accurately labeling a specimen accurately giving a medical treatment to a subject or patient are provided. The methods comprise reading a machine-readable subject identification label associated with a subject using a portable label reader; reading a machine-readable subject identification label associated with a collection receptacle or a machine-readable subject identification label associated with a medical treatment intended to be given to the subject using the portable label reader; and indicating whether the two machine-readable subject identification labels correspond to each other using the portable label reader, wherein a specimen is taken from the subject, deposited in the collection receptacle and/or the label is affixed to the collection receptacle, or the medical treatment is given to the subject when the two machine-readable subject identification labels correspond. Systems and hand-held apparatuses for accurately labeling a specimen and accurately giving a medical treatment to a subject or patient are also provided.

### CROSS REFERENCE TO RELATED APPLICATIONS

This application claims the benefit of U.S. Provisional No. 61/247,358, filed Sep. 30, 2009, entitled “Method and System for Accurately Labeling A Specimen and Treating A Subject,” by Thomas L. Cantor, the contents of which are incorporated by reference herein in their entirety.

### FIELD OF THE INVENTION

The present invention relates generally to managing inventory taken from or destined for the benefit of individual subjects or patients, often in healthcare facilities or settings, and more particularly to methods and systems for accurately managing, including labeling, storing and monitoring, specimens obtained from a subject, or medical treatments given to a subject. It is an invention intended to assure the accuracy of labels of materials taken from subjects such as patients, and that materials or procedures labeled for individual subjects such as patients are accurately and correctly assigned or administered to the intended subjects or patients.

### BACKGROUND

In healthcare facilities, specimens are commonly collected from patients by healthcare facility staff members, and must be labeled with the patient's identification. Conventionally, a phlebotomist, for example, would obtain a specimen, e.g., blood sample from a patient and carry the collection receptacle (e.g., a tube) holding the blood sample to a nurse's station, where an identification label would be generated to be affixed to the collection receptacle. Also, in blood collection facilities, blood donations are commonly collected from donors by facility staff members, and must be labeled with the donor's identification. Conventionally, a label for a blood donation receptacle would be pre-generated and placed on a blood collection bag or bottle. That bag or bottle would be carried over to the blood donor and the blood would be collected into that bag or bottle. Also, in hospitals, organs are commonly collected from donors by healthcare staff members, and must be labeled with the donor's identification. Conventionally, a label for the donor organ receptacle would be pre-generated and placed on the organ receptacle. The organ receptacle would be carried over to the site where the organ is removed from the donor. Also, in hospitals, organs, prosthetics, pharmaceuticals or therapeutics are commonly prepared by healthcare staff members or pharmacy staff members and designated for a particular patient with a label with the patient's identification information. Conventionally, a label or attached documentation that accompanies the materials or procedures with the patient's identification information is prepared. That label or attached documentation is used to identify which patient the material or procedure is to be used for.

However, using the conventional technique of labeling specimens, mislabeling too often occurs due to human error in generating or selecting the correct label to be affixed to the collection receptacle or to the intended medical treatment. For example, the phlebotomist (or any healthcare facility caregiver) may input the wrong identification information into the label generator at the nurse's station. In addition, multiple patients in the healthcare facility or setting may share a common name, which can result in the inadvertent generation of an identification label identifying a different patient with the common name. In addition, more than one label may be generated at the same station for more than one patient and the wrong label may be selected to be affixed to the specimen.

Therefore, there is a need in the art for a portable (e.g., hand-held) device capable of reading and/or storing a machine-readable patient identification label at the location of taking the specimen, capable of reading and/or storing another machine-readable patient identification label to be affixed to the collection receptacle, typically at a location different from the specimen-taking location, and capable of indicating whether the two machine-readable patient identification labels correspond to each other in order to assure that the label to be affixed to the collection receptacle accurately identifies the patient from whom the specimen is taken. There is also a need for a hand held device to store the information of the information received from the patient or by the patient's bedside or chart and the label so that at the end of the day there might be a double check that the label associated with the specimen corresponded with the patient's identifier read from the patient wrist band or other documentation. There is also a need for a portable device to be able to transmit by wireless signal to a station the label and patient information so that progress for the phlebotomist can be tracked. Some medical treatments, e.g., chemotherapies or pain killers, can be administered at a patient's home, or specimens can be collected at a patient's home. The hand held device can also be used to confirm that the label affixed to either the medical treatment, e.g., therapeutic, or specimen receptacle agrees with the patient identifier on a patient's card or other documentation at the home of the patient. The present invention addresses this and other related needs in the art.

### SUMMARY OF THE INVENTION

The presently disclosed embodiments that are directed to solving issues relating to one or more of the problems presented in the art, as well as providing additional features that will become readily apparent by reference to the following detailed description when taken in conjunction with the accompanying drawings.

Methods, Systems and Apparatuses for Accurately Labeling a Specimen Taken from a Subject

In one aspect, the present invention provides for methods of accurately labeling a specimen taken from a subject, comprising: a) reading a machine-readable subject identification label associated with a subject using a portable label reader; b) reading a machine-readable subject identification label associated with a collection receptacle using the portable label reader; and c) indicating whether the two machine-readable subject identification labels correspond to each other using the portable label reader, wherein a specimen is taken from the subject, deposited in the collection receptacle and/or the label is affixed to the collection receptacle only when the two machine-readable subject identification labels correspond to each other.

The various steps of the present methods can be conducted in any suitable order. In one example, step a) is conducted before step b). In another example, step a) is conducted after step b).

The various steps of the present methods can be conducted in any suitable location. In one example, steps a) and b) are conducted in the same location, e.g., at the place where the subject is located. In another example, steps a) and b) are conducted in different locations, e.g., step a) being conducted at the place where the subject is located, and step b) being conducted at the place where a collection receptacle is assigned or prepared.

The portable label reader used in the present methods can be configured to store information on the machine-readable subject identification label(s). In one example, the portable label reader stores information on at least one of the machine-readable subject identification labels. In another example, the portable label reader stores information on both of the machine-readable subject identification labels.

In an exemplary embodiment, step a) is conducted at a location where the specimen is obtained from the subject and/or deposited in the collection receptacle, e.g., in patient's room in a hospital; step b) is conducted at another location where the machine-readable subject identification label associated with the collection receptacle is intended to be affixed to the collection receptacle, e.g., in nurse's station or workroom; and in step c), the machine-readable subject identification label associated with the collection receptacle is affixed to the collection receptacle only when the two machine-readable subject identification labels correspond to each other.

In another exemplary embodiment, step a) is conducted at a location where the specimen is intended to be obtained from the subject and/or to be deposited in the collection receptacle, e.g., in patient's room in a hospital; step b) is conducted at another location where the machine-readable subject identification label associated with the collection receptacle is affixed to the collection receptacle, e.g., in nurse's station or workroom; and in step c), the specimen is obtained from the subject and/or deposited in the collection receptacle only when the two machine-readable subject identification labels correspond to each other.

Any suitable machine-readable subject or patient identification label can be used in the present methods. In one example, at least one of the machine-readable subject identification labels comprises a barcode, a radio frequency identification (RFID) tag or an optical character recognition (OCR) device. In another example, both of the machine-readable subject identification labels comprise a barcode, a radio frequency identification (RFID) tag or an optical character recognition (OCR) device.

The machine-readable patient identification labels can take any suitable forms, and can be located or attached to any suitable locations, on or off the subjects or patients, or on or off the collection receptacle. In one example, the machine-readable subject identification label associated with a subject is comprised in a wristband attached to a subject, a patient, a patient identification card or documentation associated with the patient. In another example, the machine-readable subject identification label associated with a subject is a machine-readable label attached to the clothing of the subject, the bed for the subject, the room where the subject is located, or a medical device or a component in the room where the subject is located. In still another example, the machine-readable subject identification label associated with a collection receptacle can be attached to the collection receptacle, or attached to or contained in the documentation associated with the patient and/or the collection receptacle.

The machine-readable subject or patient identification labels are used to identify the specimen from the same subject or patient. Preferably, the machine-readable subject identification label associated with a subject and the machine-readable subject identification label associated with a collection receptacle share at least some common features that can be used by the portable label reader to match the two machine-readable labels. In one embodiment, both machine-readable labels can be generated from the same source that identifies the subject or patient, or a blood, organ, tissue, sperm or egg donor. For example, when a patient initially checked or registered in a healthcare facility or setting, e.g., initially checked or registered in a hospital, machine-readable patient identification information can be generated to identify the patient, and such initial patient identification information can be stored in a master file, whether a hard copy file or an electronic file. The stored initial patient identification information can be used to generate both the machine-readable subject identification label associated with a subject and the machine-readable subject identification label associated with a collection receptacle. Subsequently, one machine-readable subject identification label can be associated physically to a patient when a specimen is obtained from the patient and deposited in a collection receptacle. The other machine-readable label can be used as label that is intended to be affixed to the collection receptacle.

It is not necessary that the machine-readable subject identification label associated with a subject and the machine-readable subject identification label associated with a collection receptacle are identical, so long as the two machine-readable labels share at least some common features that can be used by the portable label reader to match them. In one example, the two machine-readable subject identification labels are identical. In another example, the two machine-readable subject identification labels are different.

The present methods can be used at any suitable location or setting, including a healthcare facility, a healthcare setting or a home. Exemplary healthcare facilities include a hospital, a physician's office, a clinic, a clinical laboratory, a pharmacy, a blood donation station, a sperm or egg collection center, an organ donation station, a morgue or other tissue collection facility, and a veterinary or animal-care facility. The present methods can also be used at a patient's home. In one specific example, the present methods are used in a hospital, step a) is conducted in a patient's room, and step b) is conducted in a nurse's office or workroom.

The present methods can be used at any suitable location or setting, including healthcare settings outside a healthcare facility. In one specific example, the present methods are used in healthcare settings outside a healthcare facility for blood donation. In another specific example, the present methods are used in animal studies, preclinical studies and clinical studies, and used in connection with human or animal subjects.

The present methods can be used to accurately label any suitable specimen, e.g., a specimen taken from a subject or patient in a healthcare facility or setting. The specimen can be a biological fluid, a biological tissue, a biological organ, or a mixture thereof. Examples of biological fluids include urine, blood, plasma, serum, saliva, semen, stool, sputum, cerebral spinal fluid, tears, mucus, amniotic fluid or the like. Biological tissues are aggregate of cells, usually of a particular kind together with their intercellular substance that form one of the structural materials of a human, or an animal, including connective, epithelium, muscle and nerve tissues. Examples of biological tissues also include organs, tumors, lymph nodes, arteries and individual cell(s). In a preferred embodiment, the specimen is whole blood, plasma, serum, urine or saliva.

Any suitable collection receptacles can be used in the present methods. For example, the collection receptacle can be a tube, a cuvette, a container, a tissue or organ transport container, a temperature controlled container or a microtiter plate.

Any suitable indicators can be used to indicate whether the machine-readable subject identification label associated with a subject and the machine-readable subject identification label associated with a collection receptacle correspond to or match each other or not. For example, lights such as green or red color lights, sounds such as alarm, buzz or music, and vibration signals, can be used as the indicators. In one example, the indicating step comprises illuminating a first indicator, e.g., green light, on the label reader when the two machine-readable labels correspond to or match each other. In another example, the indicating step comprises illuminating a second indicator, e.g., red light, on the label reader when the two machine-readable labels do not correspond to each other. In still another example, the indicating step comprises sounding an alarm on the label reader when the two machine-readable labels do not correspond to each other. In another embodiment, the device may contain, and/or the method may use, a WiFi capability to set off a signal, e.g., an alarm, in a supervisor station.

The present methods may further comprise a step of storing an identification of a person, e.g., caregiver, phlebotomist or researcher, obtaining the specimen from the subject or patient. Such identification information of the person can be used to manage, e.g., organize, store and monitor, the identities of the subject(s) or patient(s) and the information on the specimens obtained by the person from the subject(s) or patient(s). For example, The present methods may further comprise a step of generating a record comprising one or more identification of one or more subject or patients, respectively, associated with the identification of the person, e.g., caregiver, phlebotomist or researcher, obtaining respective specimens.

In one specific embodiment, the present invention provides for the methods of accurately labeling a specimen taken from a subject, preferably, a patient or a blood, tissue, sperm or egg donor, in a healthcare facility or setting, comprising: reading and storing a first machine-readable subject or patient identification label with a portable label reader at a first location in the healthcare facility or setting where the specimen is deposited in a collection receptacle; reading a second machine-readable subject or patient identification label with the portable label reader at a second location in the healthcare facility or at a patient's home or setting where the second machine-readable label is intended to be affixed to the collection receptacle or where the patient is from which a specimen is to be taken or a therapeutic is to be administered (for confirmation that the therapeutic or labeled receptacle is labeled correctly with regards to the patient's identifier; and indicating whether the first and second machine-readable subject or patient identification labels correspond to or match each other with the portable label reader, wherein the second machine-readable subject or patient identification label is affixed to the collection receptacle only when the first and second machine-readable subject or patient identification labels correspond to or match each other.

In another specific embodiment, the present invention provides for methods of accurately labeling a specimen taken from a subject, preferably, a patient or a blood, tissue, sperm or egg donor, in a healthcare facility or setting, comprising: reading and storing a first machine-readable subject identification label with a portable label reader at a first location in the healthcare facility or setting where the first machine-readable label is affixed to a collection receptacle; reading a second machine-readable subject identification label with the portable label reader at a second location in the healthcare facility or setting where the specimen is to be deposited in the collection receptacle; and indicating whether the first and second machine-readable subject identification labels correspond to each other with the portable label reader, wherein the specimen is deposited in the collection receptacle with the affixed first machine-readable subject identification label only when the first and second machine-readable subject identification labels correspond to each other.

In another aspect, the present invention provides for systems for accurately labeling a specimen taken from a subject, comprising: a label reader unit configured to read a machine-readable subject identification label associated with a subject; read a machine-readable subject identification label associated with a collection receptacle; and indicate whether the two machine-readable subject identification labels correspond to each other.

The label reader unit in the systems can be configured to store information on the machine-readable subject identification label(s). In one example, the label reader unit is configured to store information on at least one of the machine-readable subject identification label associated with a subject and the machine-readable subject identification label associated with a collection receptacle. In another example, the label reader unit is configured to store information on both of the machine-readable subject identification labels.

In one specific embodiment, the label reader unit is configured to read and store a first machine-readable subject identification label at a first location where the specimen is deposited in a collection receptacle, e.g., in a patient's room in a hospital, and to read a second machine-readable subject identification label at a second location where the second machine-readable label is intended to be affixed to the collection receptacle, e.g., in a nurse's station or workroom, and the label reader unit is further configured to indicate whether the first and second machine-readable subject identification labels correspond to each other.

In another specific embodiment, the label reader unit is configured to read and store a first machine-readable subject identification label at a first location where the first machine-readable label is affixed to a collection receptacle, e.g., in a nurse's station or workroom, and to read a second machine-readable subject identification label at a second location in the healthcare facility or setting where the specimen is to be deposited in the collection receptacle, e.g., in a patient's room in a hospital, and the label reader unit is further configured to indicate whether the first and second machine-readable subject identification labels correspond to each other.

Any suitable machine-readable subject or patient identification labels can be used in connection with the present systems. In one example, the machine-readable subject identification label associated with a subject and/or the machine-readable subject identification label associated with a collection receptacle comprises a barcode, and the label reader unit is configured to read, store and process, e.g., match, a barcode. In another example, the machine-readable subject identification label associated with a subject and/or the machine-readable subject identification label associated with a collection receptacle comprises an RFID tag, and the label reader unit is configured to read, store and process, e.g., match, an RFID tag or an optical character recognition (OCR) device.

The present systems may further comprise a specimen collection receptacle. Exemplary specimen collection receptacles include a tube, a cuvette, a container, a tissue or organ transport container, a temperature controlled container or a microtiter plate.

Any suitable indicators can be used in connection with the present systems to indicate whether the machine-readable subject identification label associated with a subject and the machine-readable subject identification label associated with a collection receptacle correspond to or match each other or not. For example, lights such as green or red color lights, sounds such as alarm, buzz or music, and vibration signals, can be used as the indicators. In one example, the label reader unit is configured to illuminate a first indicator, e.g., green light, on the label reader when the two machine-readable subject or patient identification labels correspond to each other. In another example, the label reader unit is configured to illuminate a second indicator, e.g., red light, on the label reader when the two machine-readable subject or patient identification labels do not correspond to each other. In still another example, the label reader unit is configured to sound an alarm on the label reader when the two machine-readable subject or patient identification labels do not correspond to each other.

The present systems may further comprise a memory unit configured to store an identification of a person, e.g., caregiver, phlebotomist or researcher, obtaining the specimen from the subject or patient. Such identification information of a person, e.g., caregiver, phlebotomist or researcher, can be used to manage, e.g., organize, store and monitor the identities of the subject(s) or patient(s) and the information on the specimens obtained by the person from the subject(s) or patient(s). For example, The present methods may further comprise a step of generating a record comprising one or more identification of one or more subjects or patients, respectively, associated with the identification of the person, e.g., caregiver, phlebotomist or researcher, obtaining respective specimens. Accordingly, the label reader unit in the present systems may further comprise a processing unit configured to associate a machine-readable subject or patient identification label with the identification of the person, e.g., caregiver, phlebotomist or researcher, obtaining the specimen. The present systems may further comprise a processing unit configured to generate a record comprising one or more machine-readable subject or patient identification labels, respectively, associated with the identification of the person, e.g., caregiver, phlebotomist or researcher, obtaining respective specimens.

In one specific embodiment, the present invention provides for systems for accurately labeling a specimen taken from a subject or patient in a healthcare facility or setting, comprising: a label reader unit configured to read and store a first machine-readable subject or patient identification label at a first location in the healthcare facility or setting where the specimen is deposited in a collection receptacle, and to read a second machine-readable subject or patient identification label at a second location in the healthcare facility or setting where the second machine-readable label is intended to be affixed to the collection receptacle, wherein the label reader unit is configured to indicate whether the first and second machine-readable subject or patient identification labels correspond to or match each other.

In another specific embodiment, the present invention provides for systems for accurately labeling a specimen taken from a subject or patient in a healthcare facility or setting, comprising: a label reader unit configured to read and store a first machine-readable subject identification label at a first location in the healthcare facility or setting where the first machine-readable label is affixed to a collection receptacle, and to read a second machine-readable subject identification label at a second location in the healthcare facility or setting where the specimen is to be deposited in the collection receptacle, wherein the label reader unit is configured to indicate whether the first and second machine-readable subject identification labels correspond to each other.

In still another aspect, the present invention provides for hand-held apparatuses for accurately labeling a specimen taken from a subject, comprising: a label reader reading and storing a first machine-readable subject identification label at a first location where the specimen is deposited in a collection receptacle, and reading a second machine-readable subject identification label at a second location where the second machine-readable label is intended to be affixed to the collection receptacle; and an indicator unit indicating whether the first and second machine-readable subject identification labels correspond to each other.

In yet another aspect, the present invention provides for hand-held apparatuses for accurately labeling a specimen taken from a subject, comprising: a label reader reading and storing a first machine-readable subject identification label at a first location where the first machine-readable label is affixed to a collection receptacle, and reading a second machine-readable subject identification label at a second location where the specimen is to be deposited in the collection receptacle; and an indicator unit indicating whether the first and second machine-readable subject identification labels correspond to each other.

Any suitable machine-readable subject or patient identification labels can be used in connection with the present hand-held apparatuses. In one example, the machine-readable subject identification label associated with a subject and/or the machine-readable subject identification label associated with a collection receptacle comprises a barcode, and the label reader is configured to read, store and process, e.g., match, a barcode. In another example, the machine-readable subject identification label associated with a subject and/or the machine-readable subject identification label associated with a collection receptacle comprises an RFID tag or an optical character recognition (OCR) device, and the label reader is configured to read, store and process, e.g., match, an RFID tag, or an optical character recognition (OCR) device.

Any suitable indicators can be used in connection with the present hand-held apparatuses to indicate whether the two machine-readable subject or patient identification labels correspond to or match each other or not. For example, lights such as green or red color lights, sounds such as alarm, buzz or music, and vibration signals, can be used as the indicators. In one example, the indicator unit is configured to illuminate a first indicator, e.g., green light, on the label reader when the two machine-readable subject or patient identification labels correspond to each other. In another example, the indicator unit is configured to illuminate a second indicator, e.g., red light, on the label reader when the two machine-readable subject or patient identification labels do not correspond to each other. In still another example, the indicator unit is configured to sound an alarm on the label reader when the two machine-readable subject or patient identification labels do not correspond to each other.

In one specific embodiment, the present invention provides for hand-held apparatuses for accurately labeling a specimen taken from a subject or patient in a healthcare facility or setting, comprising: a label reader reading and storing a first machine-readable subject or patient identification label at a first location in the healthcare facility or setting where the specimen is deposited in a collection receptacle, and reading a second machine-readable subject or patient identification label at a second location in the healthcare facility or setting where the second machine-readable label is intended to be affixed to the collection receptacle; and an indicator unit indicating whether the first and second machine-readable subject or patient identification labels correspond to or match each other.

In another specific embodiment, the present invention provides for hand-held apparatuses for accurately labeling a specimen taken from a subject or patient in a healthcare facility or setting, comprising: a label reader reading and storing a first machine-readable subject identification label at a first location in the healthcare facility or setting where the first machine-readable label is affixed to a collection receptacle, and reading a second machine-readable subject identification label at a second location in the healthcare facility or setting where the specimen is to be deposited in the collection receptacle; and an indicator unit indicating whether the first and second machine-readable subject identification labels correspond to each other.

Certain embodiments are configured to store an identification of a person, e.g., a caregiver, obtaining the specimen from the patient, such that an identification of all patients from whom specimens are taken are associated with the particular person or caregiver obtaining the specimens, in order to generate a future record.

### Methods, Systems and Apparatuses for Accurately Giving a Medical Treatment to a Subject

In one aspect, the present invention provides for methods of accurately giving a medical treatment to a subject, comprising: a) reading a machine-readable subject identification label associated with a subject using a portable label reader; b) reading a machine-readable subject identification label associated with a medical treatment intended to be given to the subject using the portable label reader; and c) indicating whether the two machine-readable subject identification labels correspond to each other using the portable label reader, wherein the medical treatment is given to the subject only when the two machine-readable subject identification labels correspond to each other.

The various steps of the present methods can be conducted in any suitable order. In one example, step a) is conducted before step b). In another example, step a) is conducted after step b).

The various steps of the present methods can be conducted in any suitable location. In one example, steps a) and b) are conducted in the same location, e.g., at the place where the subject is treated. In another example, steps a) and b) are conducted in different locations, e.g., step a) is conducted at the place where the subject is treated, and step b) is conducted at the place where a medical treatment is assigned or prepared.

The portable label reader used in the present methods can be configured to store information on the machine-readable subject identification label(s). In one example, the portable label reader stores information on at least one of the machine-readable subject identification labels. In another example, the portable label reader stores information on both of the machine-readable subject identification labels.

In an exemplary embodiment, step a) is conducted at a location where the medical treatment is intended to be given to the subject; step b) is conducted at another location where the medical treatment is assigned or prepared; and in step c), the medical treatment is given to the subject only when the two machine-readable subject identification labels correspond to each other.

Any suitable machine-readable subject or patient identification label can be used in the present methods. In one example, at least one of the machine-readable subject identification labels comprises a barcode, a radio frequency identification (RFID) tag or an optical character recognition (OCR) device. In another example, both of the machine-readable subject identification labels comprise a barcode, a radio frequency identification (RFID) tag or an optical character recognition (OCR) device.

The machine-readable patient identification labels can take any suitable forms, and can be located or attached to any suitable locations, on or off the subjects or patients, or on or off the item(s) used for the medical treatment. In one example, the machine-readable subject identification label associated with a subject is comprised in a wristband attached to a subject, a patient, a patient identification card or documentation associated with the patient. In another example, the machine-readable subject identification label associated with a subject is a machine-readable label attached to clothing of the subject, a bed for the subject, a room where the subject is located, or a medical device or a component in the room where the subject is located. In still another example, the machine-readable subject identification label associated with a medical treatment can be attached to an instrument, a system, a device, a component and a substance used for the medical treatment, or attached to or contained in documentation associated with the patient and/or the medical treatment.

The machine-readable subject or patient identification labels are used to identify the subject or patient for the intended medical treatment. Preferably, the machine-readable subject identification label associated with a subject and the machine-readable subject identification label associated with a medical treatment intended to be given to the subject share at least some common features that can be used by the portable label reader to match the two machine-readable labels. In one embodiment, both machine-readable labels can be generated from the same source that identifies the subject or patient. For example, when a patient initially checked or registered in a healthcare facility or setting, e.g., initially checked or registered in a hospital, machine-readable patient identification information can be generated to identify the patient, and such initial patient identification information can be stored in a master file, whether a hard copy file or an electronic file. The stored initial patient identification information can be used to generate both the machine-readable subject identification label associated with a subject and the machine-readable subject identification label associated with an intended medical treatment. Subsequently, one machine-readable subject identification label can be associated physically to a patient before or when a patient is treated. The other machine-readable label can be used as label that identifies the intended medical treatment for the patient.

It is not necessary that the machine-readable subject identification label associated with a subject and the machine-readable subject identification label associated with a medical treatment are identical, so long as the two machine-readable labels share at least some common features that can be used by the portable label reader to match them. In one example, the two machine-readable subject identification labels are identical. In another example, the two machine-readable subject identification labels are different.

The present methods can be used at any suitable location or setting, including a healthcare facility, a healthcare setting or a home. Exemplary healthcare facilities include a hospital, a physician's office, a clinic, a clinical laboratory, a pharmacy, a blood donation station, a sperm or egg collection center, an organ donation station, a morgue or other tissue collection facility, and a veterinary or animal-care facility. The present methods can also be used at a patient's home. In one specific example, the present methods are used in a hospital, step a) is conducted in a patient's room or an operation room, and step b) is conducted in a physician's or nurse's office or workroom. In another specific example, the present methods are used in a healthcare setting outside a healthcare facility. In still another specific example, the present methods are used in connection with an animal or human study, a preclinical study or a clinical study.

The present methods can be used to accurately give any suitable medical treatment to a subject or patient. In one example, the medical treatment comprises administering a medical substance to the subject. Exemplary medical substances include therapeutic, preventive, diagnostic or prognostic substances. The medical substance can also be a drug. In another example, the medical treatment comprises administering a medical procedure to the subject. Exemplary medical procedures include a surgery, a radiotherapy, a chemotherapy, an implantation of a medical device, or a diagnostic or prognostic procedure.

Any suitable indicators can be used to indicate whether the machine-readable subject identification label associated with a subject and the machine-readable subject identification label associated with a medical treatment intended to be given to the subject correspond to or match each other or not. For example, lights such as green or red color lights, sounds such as alarm, buzz or music, and vibration signals, can be used as the indicators. In one example, the indicating step comprises illuminating a first indicator, e.g., green light, on the label reader when the two machine-readable labels correspond to or match each other. In another example, the indicating step comprises illuminating a second indicator, e.g., red light, on the label reader when the two machine-readable labels do not correspond to each other. In still another example, the indicating step comprises sounding an alarm on the label reader when the two machine-readable labels do not correspond to each other. In another embodiment, the device may contain, and/or the method may use a WiFi capability to set off a signal, e.g., an alarm, in a supervisor station.

The present methods may further comprise a step of storing an identification of a person, e.g., a physician, a surgeon, a nurse, a pharmacist, a caregiver, a researcher or a veterinarian, giving the medical treatment to the subject or patient. Such identification information of the person giving the medical treatment can be used to manage, e.g., organize, store and monitor, the identities of the subject(s) or patient(s) and the information on the medical treatment(s) given to the subject(s) or patient(s). For example, The present methods may further comprise a step of generating a record comprising one or more identification of one or more subject or patients, respectively, associated with the identification of the person, e.g., a physician, a surgeon, a nurse, a pharmacist, a caregiver, a researcher or a veterinarian, giving respective medical treatments.

In another aspect, the present invention provides for systems for accurately monitoring a medical treatment to a subject, comprising a label reader unit configured to read a machine-readable subject identification label associated with a subject; read a machine-readable subject identification label associated with a medical treatment intended to be given to the subject; and indicate whether the two machine-readable subject identification labels correspond to each other.

The label reader unit in the systems can be configured to store information on the machine-readable subject identification label(s). In one example, the label reader unit is configured to store information on at least one of the machine-readable subject identification label associated with a subject and the machine-readable subject identification label associated with a medical treatment intended to be given to the subject. In another example, the label reader unit is configured to store information on both of the machine-readable subject identification labels.

In one specific embodiment, the label reader unit is configured to read and/or store a machine-readable subject identification label associated with a subject at a location where the medical treatment is intended to be given to the subject; to read and/or store a machine-readable subject identification label associated with a medical treatment at another location where the medical treatment is assigned or prepared; and the label reader unit is further configured to indicate whether the first and second machine-readable subject identification labels correspond to each other.

Any suitable machine-readable subject or patient identification labels can be used in connection with the present systems. In one example, the machine-readable subject identification label associated with a subject and/or the machine-readable subject identification label associated with a medical treatment intended to be given to the subject comprises a barcode, and the label reader unit is configured to read, store and process, e.g., match, a barcode. In another example, the machine-readable subject identification label associated with a subject and/or the machine-readable subject identification label associated with a medical treatment intended to be given to the subject comprises an RFID tag or an optical character recognition (OCR) device, and the label reader unit is configured to read, store and process, e.g., match, an RFID tag or an optical character recognition (OCR) device.

Any suitable indicators can be used in connection with the present systems to indicate whether the machine-readable subject identification label associated with a subject and the machine-readable subject identification label associated with a medical treatment intended to be given to the subject correspond to or match each other or not. For example, lights such as green or red color lights, sounds such as alarm, buzz or music, and vibration signals, can be used as the indicators. In one example, the label reader unit is configured to illuminate a first indicator, e.g., green light, on the label reader when the two machine-readable subject or patient identification labels correspond to each other. In another example, the label reader unit is configured to illuminate a second indicator, e.g., red light, on the label reader when the two machine-readable subject or patient identification labels do not correspond to each other. In still another example, the label reader unit is configured to sound an alarm on the label reader when the two machine-readable subject or patient identification labels do not correspond to each other.

The present systems may further comprise a memory unit configured to store an identification of a person, e.g., a physician, a surgeon, a nurse, a pharmacist, a caregiver, a researcher or a veterinarian, administering the medical treatment to the subject. Such identification information of a person administering the medical treatment to the subject can be used to manage, e.g., organize, store and monitor the identities of the subject(s) or patient(s) and the information on the treatments given to the subject(s) or patient(s). For example, the present methods may further comprise a step of generating a record comprising one or more identification of one or more subjects or patients, respectively, associated with the identification of the person administering the medical treatment. Accordingly, the label reader unit in the present systems may further comprise a processing unit configured to associate a machine-readable subject identification label with the identification of the person administering the medical treatment to the subject. The present systems may further comprise a processing unit configured to generate a record comprising one or more machine-readable subject identification labels, respectively, associated with the identification of the person administering the respective medical treatments.

In still another aspect, the present invention provides for hand-held apparatuses for accurately monitoring a medical treatment to a subject, comprising: a label reader reading and/or storing a machine-readable subject identification label associated with a subject at a location where the subject is treated, reading and/or storing a machine-readable subject identification label associated with a medical treatment intended to be given to the subject at a location where the medical treatment is assigned or prepared; and an indicator unit indicating whether the two machine-readable subject identification labels correspond to each other.

Any suitable machine-readable subject or patient identification labels can be used in connection with the present hand-held apparatuses. In one example, the machine-readable subject identification label associated with a subject and/or the machine-readable subject identification label associated with a medical treatment intended to be given to the subject comprises a barcode, and the label reader is configured to read, store and process, e.g., match, a barcode. In another example, the machine-readable subject identification label associated with a subject and/or the machine-readable subject identification label associated with a medical treatment intended to be given to the subject comprises an RFID tag or an optical character recognition (OCR) device, and the label reader is configured to read, store and process, e.g., match, an RFID tag, or an optical character recognition (OCR) device.

Any suitable indicators can be used in connection with the present hand-held apparatuses to indicate whether the two machine-readable subject or patient identification labels correspond to or match each other or not. For example, lights such as green or red color lights, sounds such as alarm, buzz or music, and vibration signals, can be used as the indicators. In one example, the indicator unit is configured to illuminate a first indicator, e.g., green light, on the label reader when the two machine-readable subject or patient identification labels correspond to each other. In another example, the indicator unit is configured to illuminate a second indicator, e.g., red light, on the label reader when the two machine-readable subject or patient identification labels do not correspond to each other. In still another example, the indicator unit is configured to sound an alarm on the label reader when the two machine-readable subject or patient identification labels do not correspond to each other.

Further features and advantages of the present disclosure, as well as the structure and operation of various embodiments of the present disclosure, are described in detail below with reference to the accompanying drawings. Of course, one of ordinary skill in the art would realize that various other features and advantages fall within the scope of the present disclosure.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an illustration of a hand-held label reader unit according to an embodiment of the present disclosure.

FIG. 2 is an illustration of internal modules of a label reader unit according to an embodiment of the present disclosure.

FIG. 3 is an illustration of a label reader unit reading a machine-readable label at a location where a specimen is obtained from a patient, according to an embodiment of the present disclosure.

FIG. 4 is an illustration of a label reader unit reading a machine-readable label at a location where the label is to be affixed to a collection receptacle, according to an embodiment of the present disclosure.

FIG. 5 is a flowchart illustrating a method of accurately labeling a specimen taken from a patient in a healthcare facility, according to an embodiment of the present disclosure.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

Unless defined otherwise, all technical and scientific terms used herein have the same meaning as is commonly understood by one of ordinary skill in the art to which this invention belongs. All patents, patent applications (published or unpublished), and other publications referred to herein are incorporated by reference in their entireties. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein the term “subject” refers to a human or animal. The human can be a patient or a human in a healthy population. The animal can be a domestic animal or a wild animal. The animal also can be a model animal used in a research setting.

As used herein the term “specimen” refers to anything that may be obtained from a subject for a medical or health related purpose. Often, a specimen may contain an analyte for which an analyte assay is desired, or may contain a substance, e.g., blood, tissue, organ, sperm or egg, to be collected or donated. The specimen may be a biological sample, such as a biological fluid or a biological tissue. Examples of biological fluids include urine, blood, plasma, serum, saliva, semen, stool, sputum, cerebral spinal fluid, tears, mucus, amniotic fluid or the like. Biological tissues are aggregate of cells, usually of a particular kind together with their intercellular substance that form one of the structural materials of a human, animal, plant, bacterial, fungal or viral structure, including connective, epithelium, muscle and nerve tissues. Examples of biological tissues also include organs, tumors, lymph nodes, arteries and individual cell(s). Examples of organs include one or more organs in major human or animal organ systems such as circulatory, digestive, endocrine, integumentary, lymphatic, muscular, nervous, reproductive, respiratory, skeletal and excretory systems.

As used herein the phrase “a machine-readable subject identification label associated with a subject” refers to a machine-readable subject identification label that is used to identify and/or verify a subject, e.g., a human or a patient, from whom a specimen is to be obtained or to whom a medical treatment is to be given. Typically, the machine-readable subject identification label is attached to or physically associated with the subject, the clothing of the subject, certain tangible items, e.g., a bed, a medical equipment, a device or a subject identification documentation, attached to or surrounding the subject, or the location, e.g., a patient's room in a hospital.

As used herein the phrase “a machine-readable subject identification label associated with a collection receptacle” refers to a machine-readable subject identification label that is used to identify and/or verify a collection receptacle to which a specimen obtained from a subject is to be deposited. Typically, the machine-readable subject identification label is attached to or physically associated with the collection receptacle, a holder for the collection receptacle, a larger system containing the collection receptacle, or an identification documentation for the collection receptacle.

As used herein the phrase “medical treatment” refers to a substance, a procedure, and/or administration of the substance or procedure to a subject for any suitable medical or health related purpose. Such exemplary substances include a therapeutic, preventive, diagnostic or prognostic substance. Such exemplary procedures include a surgery, a radiotherapy, a chemotherapy, an implantation of a medical device, or a diagnostic or prognostic procedure.

As used herein the phrase “a machine-readable subject identification label associated with a medical treatment intended to be given to the subject” refers to a machine-readable subject identification label that is used to identify and/or verify a medical treatment to be given to an intended subject, e.g., a human or a patient. Typically, the machine-readable subject identification label is attached to or physically associated with a substance to be administered to the subject, the container or packaging for the substance, an item, e.g., a medical equipment, instrument, device, or any component or connection thereof, to be used in a procedure on the subject, or a subject identification documentation for the intended medical treatment.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

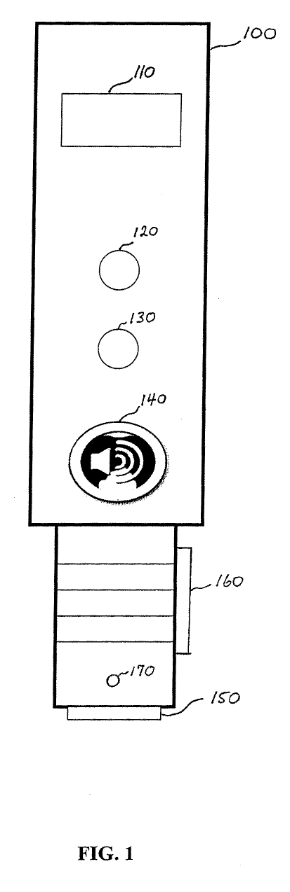

FIG. 1 is an exemplary hand-held label reader unit 100 according to an embodiment of the present disclosure. Label reader unit 100 includes label reader 110, which is a sensor capable of reading a machine-readable label or tag. It is noted that the term “machine-readable label” is used throughout the present disclosure for exemplary purposes. The machine-readable label may be any readable label or tag bearing a unique identification. For example, the machine-readable label may be a standard or 3D barcode, a radio frequency identification (RFID) tag, a magnetically encoded tag, a chip, or an optical character recognition (OCR) device, etc. Accordingly, label reader 110 may be a barcode reader or an RFID antenna, for example, or any sensing device capable of detecting a machine-readable label. Reading or scanning may be implemented by a caregiver by pressing or holding down activator button 160. Alternatively, label reader 110 may perform a continuous scan for machine-readable labels within a predetermined range. According to certain embodiments, when a new scan is to be performed, or a previous scan is to be ignored, the caregiver can press reset button 170 to initialize label reader unit 100.

Label reader unit 100 can further include first and second indicators 120 and 130, respectively, which may be in the form of lights (e.g., LEDs) of any color. According to an embodiment, first indicator 120 may be a green light, while second indicator 130 may be a red light. Of course, any number of indicators, of any color, may be included without departing from the scope of the present disclosure. In addition, or in the alternative, to first and second indicators 120 and 130, speaker 140 may be included to provide audible alarms as indications. Lights and audible alarms are described herein as indicators for exemplary purposes; however, one of ordinary skill in the art would realize that various other types of indicators may be employed without departing from the scope of the present disclosure.

Label reader unit 100 may include data port 150, which may be a USB port, for example, configured to interface with a computer terminal in order to transmit or download data stored in label reader unit 100 and/or charge a battery unit (not shown) within label reader 100. Alternatively, data port 150 may include wireless communication capabilities (e.g., WiFi) or a hard-wired connection (e.g., a local area network). According to certain embodiments, the data port 150 may include wireless local area network connectivity, complying with IEEE 802.11 standards, in order to download data stored in label reader 100. According to other embodiments, data port 150 may communicate with an off-site or central database within the healthcare facility via the internet. Any conventional means of communication, however, may be employed between data port 150 and any external processor.

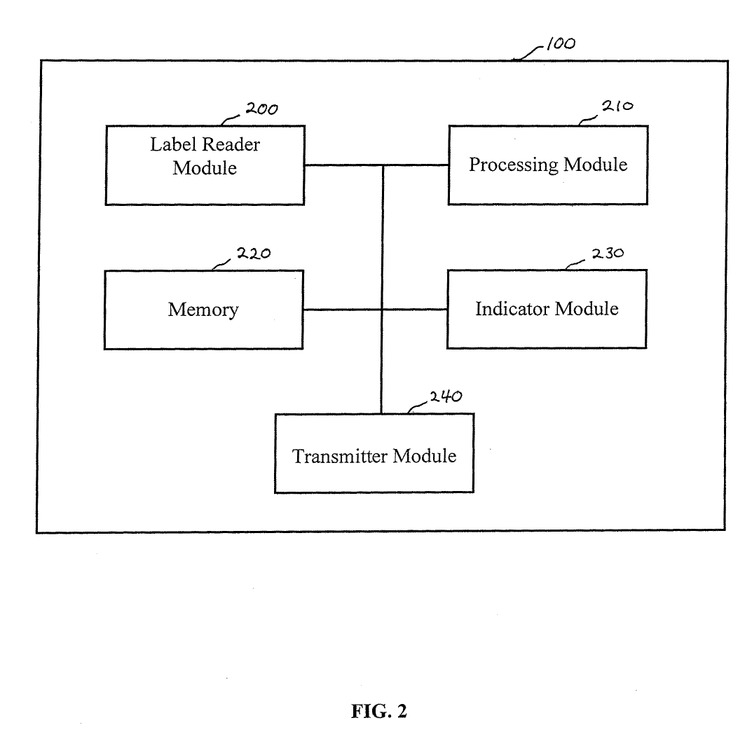

FIG. 2 is an illustration of internal modules of label reader unit 100 according to an embodiment of the present disclosure. Label reader unit 100 includes label reader module 200 as part of label reader 110, which, as described above, may be configured to read a barcode, an RFID tag, a magnetically encoded tag, a chip etc. Label reader module 200 may include the capabilities of a barcode reader or an RFID antenna, for example, as well as any sensing device capable of detecting and interpreting a machine-readable label. Label reader module 200 may also be configured to read an identification (ID) badge or electronic key of a caregiver intending to use label reader unit 100. Thereafter, the identification of each patient from which a specimen is taken by the caregiver is associated with the identification of the caregiver in memory 220. It is noted that the term “caregiver” is used throughout the description, and can refer to any healthcare facility staff member who obtains a specimen or an organ for transplant or carries a therapeutic to or from a subject or patient and/or generates a machine-readable label to identify the specimen, or a person who collects blood, tissue, sperm or egg from a donor, and/or generates a machine-readable label to identify the donated substance.

Label reader unit 100 may further include a processing unit 210. Processing module 210 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processing module 210 may comprise processing logic that is configured to carry out the functions, techniques, and processing tasks associated with the operation of label reader unit 100.

In the context of this document, a memory 220, (i.e., a computer-readable medium), can be any medium that can contain or store a program for use by or in connection with the instruction execution system, apparatus, or device. The memory 220 can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

Label reader unit 100 can include a transmitter module 240 allowing label reader unit 100 to interface with an external computer terminal using data port 150, for example, in order to download data stored in memory 220 using a USB connection, for example. Alternatively, wireless communication capabilities (e.g., WiFi) or a hard-wired connection (e.g., a local area network) may be implemented using transmitter module 240, as described above.

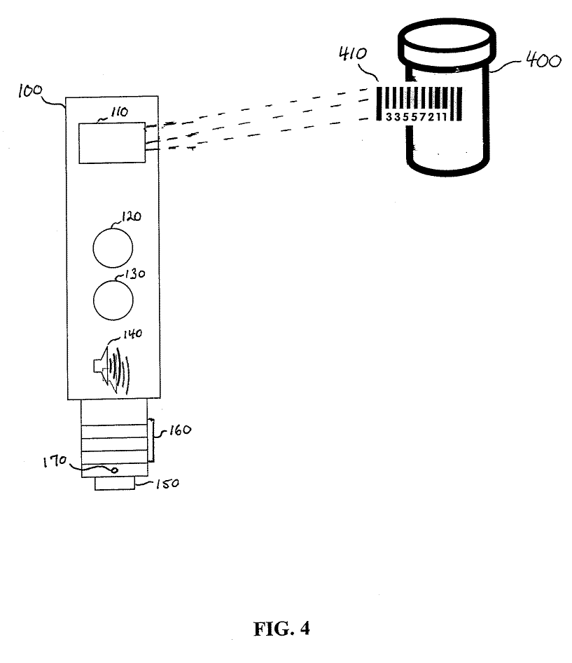

Label reader unit 100 may include indicator module 230, the functions of which will be described in greater detail below with respect to FIG. 4. Indicator module 230 can cause first and second indicators 120 and 130, respectively, to illuminate, or speaker 140 to sound an alarm based on information stored in memory 220.

These and other elements of label reader unit 100 may be interconnected together using a data communication bus, or any suitable interconnection arrangement. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

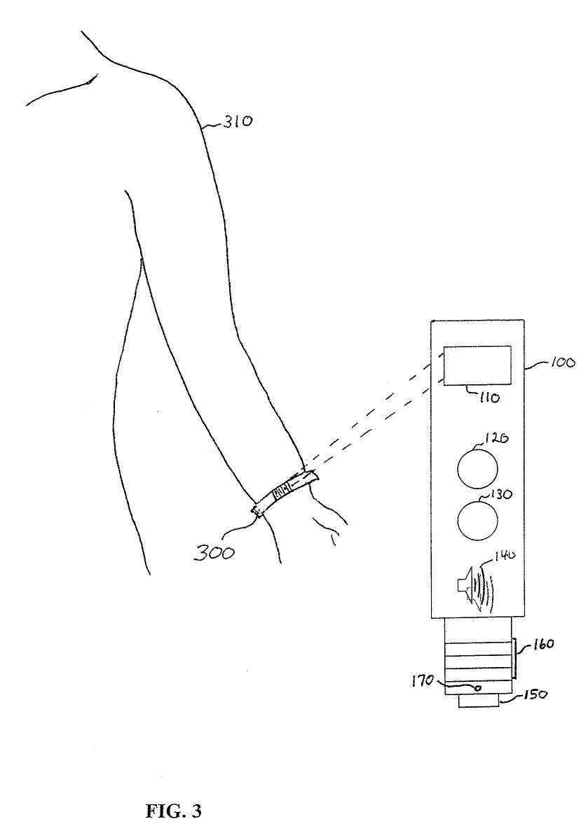

FIG. 3 is an illustration of label reader unit 100 reading a machine-readable label 300 at a location where a specimen is obtained from a patient 310, according to an embodiment of the present disclosure. In the example shown in FIG. 3, the machine-readable label 300 is a patient wristband including a barcode encoded with the identification of the patient 310. According to an embodiment, the caregiver can read the machine-readable label 300 using label reader unit 100 when a specimen (e.g., blood) is taken from patient 310 and deposited in a collection receptacle 400 (see FIG. 4 below). The dotted lines indicate label reader 110 reading or scanning the machine-readable label 300. The identification of patient 310 would then be stored in memory 220, and can be associated with the identification of the caregiver, which is previously stored in memory 220, according to certain embodiments. One of ordinary skill in the art would realize that the wristband is merely one example of machine-readable label 300, and various other types of machine-readable labels 300 or tags may be used (e.g., identification tags on patient's 310 chart or in the patient's 310 room) to indicate from which patient 310 the specimen is drawn or from which patient an organ is taken or destined or for which patient a therapeutic is intended. Of course, the use of barcode on machine-readable label 300 is for exemplary purposes, and various types of machine-readable labels may be employed.

FIG. 4 is an illustration of a label reader unit 100 reading a machine readable label 410 at a location where the label 410 is to be affixed to a collection receptacle 400, according to an embodiment of the present disclosure. After the caregiver obtains the specimen from patient 310 and deposited into collection receptacle 400, an identification label for affixing to the collection receptacle 400 can be generated at a nurse's station, for example, or any other area where collection receptacle 400 is to be stored.

When machine-readable label 410 is generated, the caregiver can use label reader unit 100 to read or scan the machine-readable label 410. The dotted lines indicate that label reader 110 reading or scanning the machine-readable label 410. Processing module 210 can then compare the identification obtained from reading machine-readable label 410 with the identification of the patient 310 stored in memory 220 and obtained from reading machine-readable label 300. If the identifications of labels 300 and 410 match, then indicator module 230 can provide an appropriate indication to the caregiver. For example, indicator module 230 can illuminate indicator 120 and/or 130 to provide a green light. Alternatively, indicator module 230 can provide an audible alarm or sound via speaker 140 indicating that the identifications of labels 300 and 410 match. Various types of indications may be employed without departing from the scope of the present disclosure. Once it is determined that the identification of generated machine-readable label 410 matches the identification of patient 310 obtained from reading machine-readable label 300, the caregiver can affix label 410 to collection receptacle 400 holding the specimen taken from patient 310. Thereafter, reset button 170 can be activated so that label reader unit 100 is initialized for obtaining a new specimen from another patient, for example.

If the device, e.g., a label reader unit, has the ability to store all of the day's labels, at the end of the day the stored labels can all be downloaded and double checked for accuracy and a record of the accuracy of the labels can be achieved for future confirmation of the accuracy of labels relative to patient identities. After the stored labels are downloaded and checked, they can be removed from the portable device and stored on another media so that at the end of the day, a new sample label or information can be read, stored and/or processed by the portable device. In some embodiments, the device may contain two reset buttons for suitable uses. For example, at the end of the day, one reset button can be used to download all of the data from the day to another media, and another reset button can be used to clear the data from the device.

On the other hand, if the identification of machine-readable label 410 does not match the identification of patient 310 stored in memory 220 and obtained from reading machine-readable label 300, then indicator module 230 can indicate this mismatch to the caregiver and even to a supervisor via a WiFi signal. For example, indicator module 230 can illuminate indicator 120 and/or 130 to provide a red light or a flashing light. Alternatively, indicator module 230 can provide an audible alarm or other sound via speaker 140 indicating that the identifications of labels 300 and 410 do not match. Accordingly, the caregiver would become aware that the label 410 should not be affixed to collection receptacle 400, holding the specimen taken from patient 310.

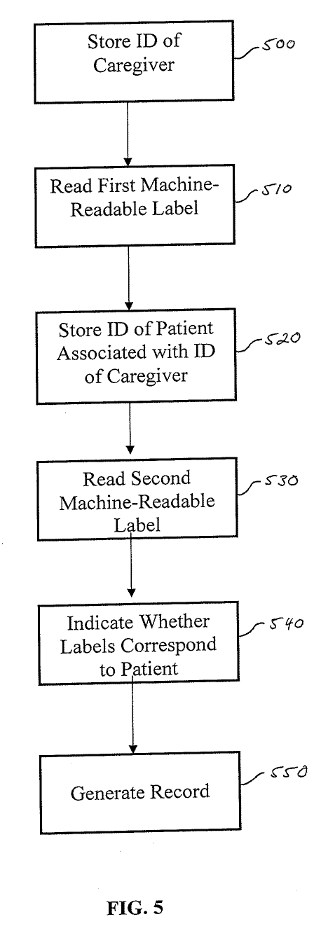

FIG. 5 is a flowchart illustrating a method of accurately labeling a specimen taken from a patient 310 in a healthcare facility, according to an embodiment of the present disclosure. When a caregiver begins his or her shift, for example, label reader unit 100 can be used, at operation 500, to obtain the identification of the caregiver. As described herein, label reader 110 can read or scan an identification badge or electronic key, for example, identifying the caregiver. Thereafter, all data input to memory 220 of label reader unit 100 can be stored in association with the identification of the caregiver in order to generate future records.

From operation 500, the process continues to operation 510, where the first machine-readable label 300 is read using label reader unit 100, as the location where a specimen is taken from patient 310. As noted above, according to certain embodiments, the caregiver may activate reset button 170 in order to initialize label reader unit 100, so that label reader unit 100 is ready to read first machine-readable label 300 when a new specimen is taken from patient 310. The caregiver may initiate the reading or scanning by depressing activator button 160, for example. Alternatively, label reader unit 100 can continuously scan for machine-readable labels within a predefined distance.

After reading machine-readable label 300, the identification of patient 310 (from whom a specimen is taken and deposited in collection receptacle 400) is stored in memory 220.

From operation 510, the process continues to operation 520 where the identification of patient 310 is stored in association with the previously obtained identification of the caregiver in memory 220.

From operation 520, the process continues to operation 530, where a second machine-readable label 410 is read by label reader unit 100. As described herein, a label 410 can be generated in order to label collection receptacle 400 holding the specimen taken from patient 310. Label 410 may be generated at a location remote from the location where the specimen is taken from patient 310. Thus, to assure that the correct label 410 is affixed to collection receptacle 400, processing module 210 of label reader unit 100 compares the identifications obtained by reading labels 300 (stored in memory 220) and 410. At operation 540, indicator module 230 of label reader unit 100 outputs an indication of whether labels 300 and 410 correspond or match.

At operation 540, indicator module 230 can illuminate indicator 120 and/or 130 to provide a green light if the labels 300 and 410 correspond or match. Alternatively, indicator module 230 can provide an audible alarm or sound via speaker 140 indicating that the identifications of labels 300 and 410 correspond or match. If the labels 300 and 410 correspond to the same patient 310, the caregiver can affix label 410 to collection receptacle 400. On the other hand, if the identification of label 410 does not match the identification of patient 310 stored in memory 220 and obtained from reading label 300, then indicator module 230 can indicate this mismatch by illuminating indicator 120 and/or 130 to provide a red light and/or a flashing light, for example. Alternatively, indicator module 230 can provide an audible alarm or other sound via speaker 140 indicating that the identifications of labels 300 and 410 do not match. At this point, the caregiver is made aware of the mismatch, and can regenerate an appropriate label 410.

At operation 550, a hard record, for example, may be generated, which provides an indication of each label read by label reader unit 100 by the particular caregiver. Data port 150, which may be a USB port, for example, is configured to interface with a computer terminal in order to download data stored in memory 220 to an external processor that can generate the record. Alternatively, the record can be generated using processing module 210 within label reader unit 100 and output using data port 150 or transmitter module 240. Transmitter module 240 may include wireless communication capabilities (e.g., WiFi) or a hard-wired connection (e.g., a local area network). According to certain embodiments, the transmitter module 240 may include wireless local area network connectivity, complying with IEEE 802.11 standards, in order to download data stored in memory 220. According to other embodiments, transmitter module 240 may communicate with an off-site or central database within the healthcare facility via the internet. Any conventional means of communication, however, may be employed between data port 150 and any external processor, using transmitter module 240.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

For example, embodiments of the present disclosure include (but are not limited to): a method of accurately labeling a specimen taken from a subject, comprising: a) reading a machine-readable subject identification label associated with a subject using a portable label reader; b) reading a machine-readable subject identification label associated with a collection receptacle using the portable label reader; and c) indicating whether the two machine-readable subject identification labels correspond to each other using the portable label reader, wherein a specimen is taken from the subject, deposited in the collection receptacle and/or the label is affixed to the collection receptacle only when the two machine-readable subject identification labels correspond to each other, and wherein step a) is conducted either before or after step b). Steps a) and b) can be conducted in the same or different locations.

Embodiments include the method of one disclosed embodiment, wherein the machine-readable subject identification label associated with a subject is comprised in a wristband attached to the subject.

Embodiments include the method of one disclosed embodiment, wherein the machine-readable subject identification label associated with a subject is a machine-readable label attached to the clothing of the subject, a bed for the subject, a room where the subject is located, or a medical device or a component in the room where the subject is located.

Embodiments include the method of one disclosed embodiment, wherein the two machine-readable subject identification labels are generated from the same stored identification information.

Embodiments include the method of one disclosed embodiment, wherein the two machine-readable subject identification labels are different.

Embodiments include the method of one disclosed embodiment, wherein the two machine-readable subject identification labels are identical.

Embodiments include the method of one disclosed embodiment, which is conducted in a healthcare facility, a healthcare setting or a home.

Embodiments include the method of one disclosed embodiment, wherein the healthcare facility or setting is selected from the group consisting of a hospital, a physician's office, a clinical laboratory, a clinic, a blood donation station, a sperm or egg collection center, an organ donation facility, a morgue or other tissue collection facility, a pharmacy and a veterinary or animal-care facility.

Embodiments include the method of one disclosed embodiment, wherein the subject is a patient or a blood, tissue, sperm, egg or organ donor.

Embodiments include the method of one disclosed embodiment, wherein the healthcare facility is a hospital, step a) is conducted in a patient's room, and step b) is conducted in a nurse's office or workroom.

Embodiments include the method of one disclosed embodiment, which is conducted in a healthcare setting outside a healthcare facility.

Embodiments include the method of one disclosed embodiment, wherein the healthcare setting is for blood, tissue, sperm or egg collection or organ donation.

Embodiments include the method of one disclosed embodiment, which is conducted in connection with an animal or human study, a preclinical study or a clinical study.

Embodiments include the method of one disclosed embodiment, wherein the specimen is selected from the group consisting of whole blood, plasma, serum, urine and saliva.

Embodiments include the method of one disclosed embodiment, wherein the collection receptacle is a tube, a cuvette, a container, a tissue or organ transport container, a temperature controlled container or a microtiter plate.

Embodiments include the method of one disclosed embodiment, wherein the indicating step comprises illuminating an indicator on the label reader when the two machine-readable subject identification labels correspond to each other.

Embodiments include the method of one disclosed embodiment, wherein the indicating step comprises illuminating an indicator on the label reader when the two machine-readable subject identification labels do not correspond to each other.

Embodiments include the method of one disclosed embodiment, wherein the indicating step comprises sounding an alarm on the label reader when the two machine-readable subject identification labels do not correspond to each other.

Embodiments include the method of one disclosed embodiment, further comprising storing an identification of a person obtaining the specimen from the subject.

Embodiments include the method of one disclosed embodiment, wherein the person obtaining the specimen from the subject is a caregiver, phlebotomist or researcher.

Embodiments include the method of one disclosed embodiment, further comprising generating a record comprising one or more identifications of one or more subjects, respectively, associated with the identification of the person obtaining respective specimens.

Yet another embodiment is directed to a system for accurately labeling a specimen taken from a subject, comprising: a label reader unit configured to: read a machine-readable subject identification label associated with a subject; read a machine-readable subject identification label associated with a collection receptacle; and indicate whether the two machine-readable subject identification labels correspond to each other.

Embodiments include the system of one disclosed embodiment, wherein the label reader unit is configured to store information on at least one of the machine-readable subject identification labels.

Embodiments include the system of one disclosed embodiment, wherein the label reader unit is configured to store information on both of the machine-readable subject identification labels.

Embodiments include the system of one disclosed embodiment, further comprising a specimen collection receptacle.

Embodiments include the system of one disclosed embodiment, wherein the specimen collection receptacle is a tube, a cuvette, a container, a tissue or organ transport container, a temperature controlled container or a microtiter plate.

Embodiments include the system of one disclosed embodiment, wherein the label reader unit comprises a memory unit configured to store an identification of a person obtaining the specimen from the subject.

Embodiments include the system of one disclosed embodiment, wherein the label reader unit further comprises a processing unit configured to associate a machine-readable subject identification label with the identification of the person obtaining the specimen.

Embodiments include the system of one disclosed embodiment, further comprising a processing unit configured to generate a record comprising one or more machine-readable subject identification labels, respectively, associated with the identification of the person obtaining the respective specimens.

Yet another embodiment is directed to a hand-held apparatus for accurately labeling a specimen taken from a subject, comprising: a label reader reading and storing a first machine-readable subject identification label at a first location where the specimen is deposited in a collection receptacle, and reading a second machine-readable subject identification label at a second location where the second machine-readable label is intended to be affixed to the collection receptacle; and an indicator unit indicating whether the first and second machine-readable subject identification labels correspond to each other.

Yet another embodiment is directed to a hand-held apparatus for accurately labeling a specimen taken from a subject, comprising: a label reader reading and storing a first machine-readable subject identification label at a first location where the first machine-readable label is affixed to a collection receptacle, and reading a second machine-readable subject identification label at a second location where the specimen is to be deposited in the collection receptacle; and an indicator unit indicating whether the first and second machine-readable subject identification labels correspond to each other.

Yet another embodiment is directed to a method of accurately giving a medical treatment to a subject, comprising: a) reading a machine-readable subject identification label associated with a subject using a portable label reader; b) reading a machine-readable subject identification label associated with a medical treatment intended to be given to the subject using the portable label reader; and c) indicating whether the two machine-readable subject identification labels correspond to each other using the portable label reader, wherein the medical treatment is given to the subject only when the two machine-readable subject identification labels correspond to each other, wherein step a) is conducted before or after step b), at the same or different locations.

Embodiments include the method of one disclosed embodiment, wherein the portable label reader stores information on at least one of the machine-readable subject identification labels.

Embodiments include the method of one disclosed embodiment, wherein the portable label reader stores information on both of the machine-readable subject identification labels.

Embodiments include the method of one disclosed embodiment, wherein: step a) is conducted at a location where the medical treatment is intended to be given to the subject; step b) is conducted at another location where the medical treatment is assigned or prepared; and in step c), the medical treatment is given to the subject only when the two machine-readable subject identification labels correspond to each other.

Embodiments include the method of one disclosed embodiment, wherein the machine-readable subject identification label associated with a subject is a machine-readable label attached to the clothing of the subject, a bed for the subject, a room where the subject is located, or a medical device or a component in the room where the subject is located.

Embodiments include the method of one disclosed embodiment, wherein the two machine-readable subject identification labels are generated from the same stored identification information.

Embodiments include the method of one disclosed embodiment, wherein the two machine-readable subject identification labels are different.

Embodiments include the method of one disclosed embodiment, wherein the two machine-readable subject identification labels are identical.

Embodiments include the method of one disclosed embodiment, which is conducted in a healthcare facility, a healthcare setting or a home.

Embodiments include the method of one disclosed embodiment, wherein the healthcare facility or setting is selected from the group consisting of a hospital, a physician's office, a clinical laboratory, a clinic, a blood donation station, a sperm or egg collection center, an organ donation facility, a morgue or other tissue collection facility, a pharmacy and a veterinary or animal-care facility.

Embodiments include the method of one disclosed embodiment, wherein the medical treatment comprises administering a medical substance to the subject.

Embodiments include the method of one disclosed embodiment, wherein the medical substance is a therapeutic, preventive, diagnostic or prognostic substance.

Embodiments include the method of one disclosed embodiment, wherein the medical substance is a drug.

Embodiments include the method of one disclosed embodiment, wherein the medical treatment comprises administering a medical procedure to the subject.

Embodiments include the method of one disclosed embodiment, wherein the medical procedure is a surgery, a radiotherapy, a chemotherapy, an implantation of a medical device, or a diagnostic or prognostic procedure.

Embodiments include the method of one disclosed embodiment, wherein the healthcare facility is a hospital. Embodiments include the method of one disclosed embodiment, which is conducted in a healthcare setting outside a healthcare facility.

Embodiments include the method of one disclosed embodiment, which is conducted in connection with an animal or human study, a preclinical study or a clinical study.

Embodiments include the method of one disclosed embodiment, wherein the indicating step comprises illuminating an indicator on the label reader when the two machine-readable subject identification labels correspond to each other.

Embodiments include the method of one disclosed embodiment, wherein the indicating step comprises illuminating an indicator on the label reader when the two machine-readable subject identification labels do not correspond to each other.

Embodiments include the method of one disclosed embodiment, wherein the indicating step comprises sounding an alarm on the label reader when the two machine-readable subject identification labels do not correspond to each other.

Embodiments include the method of one disclosed embodiment, further comprising storing an identification of a person giving the medical treatment to the subject.

Embodiments include the method of one disclosed embodiment, wherein the person giving the medical treatment is a physician, a surgeon, a nurse, a pharmacist, a caregiver, a researcher or a veterinarian.

Embodiments include the method of one disclosed embodiment, further comprising generating a record comprising one or more identifications of one or more subjects, respectively, associated with the identification of the person giving respective medical treatments.

Yet another embodiment is directed to a system for accurately monitoring a medical treatment to a subject, comprising: a label reader unit configured to: read a machine-readable subject identification label associated with a subject; read a machine-readable subject identification label associated with a medical treatment intended to be given to the subject; and indicate whether the two machine-readable subject identification labels correspond to each other.

Embodiments include the system of one disclosed embodiment, wherein the label reader unit is configured to store information on at least one of the machine-readable subject identification labels.

Embodiments include the system of one disclosed embodiment, wherein the label reader unit is configured to store information on both of the machine-readable subject identification labels.

Embodiments include the system of one disclosed embodiment, wherein the label reader unit is configured to read and/or store a machine-readable subject identification label associated with a subject at a location where the medical treatment is intended to be given to the subject; to read and/or store a machine-readable subject identification label associated with a medical treatment at another location where the medical treatment is assigned or prepared; and the label reader unit is further configured to indicate whether the first and second machine-readable subject identification labels correspond to each other.

Embodiments include the system of one disclosed embodiment, wherein the label reader unit is configured to read and/or store a machine-readable subject identification label comprising a barcode, a radio frequency identification (RFID) tag or an optical character recognition (OCR) device.

Embodiments include the system of one disclosed embodiment, wherein the label reader unit is configured to illuminate an indicator on the label reader when the first and second machine-readable subject identification labels correspond to each other.

Embodiments include the system of one disclosed embodiment, wherein the label reader unit is configured to illuminate an indicator on the label reader when the first and second machine-readable subject identification labels do not correspond to each other.

Embodiments include the system of one disclosed embodiment, wherein the label reader unit is configured to sound an alarm on the label reader unit when the first and second machine-readable subject identification labels do not correspond to each other.

Embodiments include the system of one disclosed embodiment, wherein the label reader unit comprises a memory unit configured to store an identification of a person administering the medical treatment to the subject.

Embodiments include the system of one disclosed embodiment, wherein the label reader unit further comprises a processing unit configured to associate a machine-readable subject identification label with the identification of the person administering the medical treatment to the subject.

Embodiments include the system of one disclosed embodiment, further comprising a processing unit configured to generate a record comprising one or more machine-readable subject identification labels, respectively, associated with the identification of the person administering the respective medical treatments.

Yet another embodiment is directed to a hand-held apparatus for accurately monitoring a medical treatment to a subject, comprising: a label reader reading and/or storing a machine-readable subject identification label associated with a subject at a location where the subject is treated, reading and/or storing a machine-readable subject identification label associated with a medical treatment intended to be given to the subject at a location where the medical treatment is assigned or prepared; and an indicator unit indicating whether the first and second machine-readable subject identification labels correspond to each other.

In this document, the term “module” as used herein, can refer to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to the embodiments of the invention.

In this document, the terms “computer program product”, “computer-readable medium”, “memory”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, by a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

Unless indicated otherwise, all publications and documents cited herein are incorporated by reference in their entireties. Citation of publications or documents is not intended as an admission that any of such publications or documents are pertinent prior art, nor does it constitute any admission as to the contents or date of these publications or documents.

What is claimed is:

1. A method of accurately labeling a specimen taken from a subject, comprising:
a) reading a machine-readable subject identification label associated with a subject using a portable label reader;
b) reading a machine-readable subject identification label associated with a collection receptacle using the portable label reader; and
c) indicating whether the two machine-readable subject identification labels correspond to each other using the portable label reader,
wherein a specimen is taken from the subject, deposited in the collection receptacle and/or the label is affixed to the collection receptacle only when the two machine-readable subject identification labels correspond to each other.

2. The method of claim 1, wherein the portable label reader stores information on at least one of the machine-readable subject identification labels.

3. The method of claim 1, wherein:
step a) is conducted at a location where the specimen is obtained from the subject and/or deposited in the collection receptacle;
step b) is conducted at another location where the machine-readable subject identification label associated with the collection receptacle is intended to be affixed to the collection receptacle; and
in step c), the machine-readable subject identification label associated with the collection receptacle is affixed to the collection receptacle only when the two machine-readable subject identification labels correspond to each other.

4. The method of claim 1, wherein:
step a) is conducted at a location where the specimen is intended to be obtained from the subject and/or to be deposited in the collection receptacle;
step b) is conducted at another location where the machine-readable subject identification label associated with the collection receptacle is affixed to the collection receptacle; and
in step c), the specimen is obtained from the subject and/or deposited in the collection receptacle only when the two machine-readable subject identification labels correspond to each other.

5. The method of claim 1, wherein at least one of the machine-readable subject identification labels comprises a barcode, a radio frequency identification (RFID) tag or an optical character recognition (OCR) device.

6. The method of claim 1, wherein the machine-readable subject identification label associated with a subject is comprised in a wristband attached to the subject.

7. The method of claim 1, wherein the machine-readable subject identification label associated with a subject is a machine-readable label attached to the at least one of clothing of the subject, a bed for the subject, a room where the subject is located, and a medical device or a component in the room where the subject is located.

8. The method of claim 1, wherein the indicating step comprises at least one of sounding an alarm or illuminating an indicator on the label reader when at least one of:
the two machine-readable subject identification labels correspond to each other, and
the two machine-readable subject identification labels do not correspond to each other.

9. The method of claim 1, further comprising storing an identification of a person obtaining the specimen from the subject.

10. The method of claim 9, further comprising generating a record comprising one or more identifications of one or more subjects, respectively, associated with the identification of the person obtaining respective specimens.

11. A system for accurately labeling a specimen taken from a subject, comprising:
a label reader unit configured to:
read a machine-readable subject identification label associated with a subject;
read a machine-readable subject identification label associated with a collection receptacle; and
indicate whether the two machine-readable subject identification labels correspond to each other.

12. The system of claim 11, wherein the label reader unit is configured to store information on at least one of the machine-readable subject identification labels.

13. The system of claim 11, wherein the label reader unit is configured to read and store a first machine-readable subject identification label at a first location where the specimen is deposited in a collection receptacle, and to read a second machine-readable subject identification label at a second location where the second machine-readable label is intended to be affixed to the collection receptacle, and
the label reader unit is further configured to indicate whether the first and second machine-readable subject identification labels correspond to each other.

14. The system of claim 11, wherein the label reader unit is configured to read and store a first machine-readable subject identification label at a first location where the first machine-readable label is affixed to a collection receptacle, and to read a second machine-readable subject identification label at a second location in the healthcare facility or setting where the specimen is to be deposited in the collection receptacle, and
the label reader unit is further configured to indicate whether the first and second machine-readable subject identification labels correspond to each other.

15. The system of claim 11, wherein the label reader unit is configured to read and/or store a machine-readable subject identification label comprising a barcode, a radio frequency identification (RFID) tag or an optical character recognition (OCR) device.

16. The system of claim 11, wherein the label reader unit is configured to perform at least one of sounding an alarm and illuminating an indicator on the label reader when at least one of:
the first and second machine-readable subject identification labels correspond to each other, and
the first and second machine-readable subject identification labels do not correspond to each other.

17. The system of claim 11, wherein the label reader unit comprises a memory unit configured to store an identification of a person obtaining the specimen from the subject.

18. The system of claim 17, wherein the label reader unit further comprises a processing unit configured to associate a machine-readable subject identification label with the identification of the person obtaining the specimen.

19. The system of claim 18, further comprising a processing unit configured to generate a record comprising one or more machine-readable subject identification labels, respectively, associated with the identification of the person obtaining the respective specimens.

20. A hand-held apparatus for accurately labeling a specimen taken from a subject, comprising:
a label reader configured to read and store information associated with a first machine-readable subject identification label at a first location where the first machine-readable subject identification label is affixed to a collection receptacle used to hold the specimen, and read a second machine-readable subject identification label at a second location where the second machine-readable label is intended to be affixed to the collection receptacle; and
an indicator unit configured to indicate whether the first and second machine-readable subject identification labels correspond to each other.
